(19) United States
(12) Patent Application Publication
(10) Pub. No.: US 2018/0020227 A1
(43) Pub. Date: Jan. 18, 2018

(54) COMMUNICATION APPARATUS, COMMUNICATION SYSTEM, COMMUNICATION METHOD, AND RECORDING MEDIUM

(71) Applicants: Shoh NAGAMINE, Kanagawa (JP); Takuya IMAI, Tokyo (JP); Kenichiro MORITA, Tokyo (JP); Junpei MIKAMI, Kanagawa (JP)

(72) Inventors: Shoh NAGAMINE, Kanagawa (JP); Takuya IMAI, Tokyo (JP); Kenichiro MORITA, Tokyo (JP); Junpei MIKAMI, Kanagawa (JP)

(21) Appl. No.: 15/645,329

(22) Filed: Jul. 10, 2017

(30) Foreign Application Priority Data
Jul. 13, 2016 (JP) 2016-138301

(51) Int. Cl. H04N 19/36; H04L 29/06; H04N 7/14

(52) U.S. Cl. CPC H04N 19/36; H04N 7/147; H04L 65/403; H04L 65/608; H04L 65/80

(57) ABSTRACT

A communication apparatus communicable with a counterpart communication apparatus, includes: circuitry to acquire receiver-side environment information indicating a communication environment of the counterpart communication apparatus that receives content data from the communication apparatus, determine a number of layers of the content data for scalable coding, based on the receiver-side environment information, and code the content data in the determined number of layers by using the scalable coding; and a transmitter to transmit the coded content data to the counterpart communication apparatus through a communication network.

### CROSS-REFERENCE TO RELATED APPLICATIONS

This patent application is based on and claims priority pursuant to 35 U.S.C. §119(a) to Japanese Patent Application No. 2016-138301, filed on Jul. 13, 2016, in the Japan Patent Office, the entire disclosure of which is hereby incorporated by reference herein.

### BACKGROUND

### Technical Field

The present invention relates to a communication apparatus, a communication system, a communication method, and a non-transitory recording medium.

### Description of the Related Art

Conference systems, which carry out videoconferences with remote sites over communication networks such as the Internet, are becoming widespread.

When a videoconference is held over a communication network such as the Internet, the quality of content such as video and audio content in the videoconference may sometimes vary depending on the status of the communication network.

### SUMMARY

Example embodiments of the present invention include a communication system including circuitry to: acquire receiver-side environment information indicating a communication environment of the counterpart communication apparatus that receives content data from the communication apparatus; determine a number of layers of the content data for scalable coding, based on the receiver-side environment information; code the content data in the determined number of layers by using the scalable coding, and transmit the coded content data to the counterpart communication apparatus through a communication network.

In one example, the communication system may be a communication apparatus communicable with a counterpart communication apparatus, which includes: circuitry to acquire receiver-side environment information indicating a communication environment of the counterpart communication apparatus that receives content data from the communication apparatus, determine a number of layers of the content data for scalable coding, based on the receiver-side environment information, and code the content data in the determined number of layers by using the scalable coding; and a transmitter to transmit the coded content data to the counterpart communication apparatus through a communication network.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration diagram of a videoconference system according to an embodiment of the present invention;

FIG. 2 is an illustration of an overview of communication in the videoconference system according to the embodiment;

FIGS. 3A to 3C are diagrams illustrating video data coding schemes;

FIG. 4 is a block diagram illustrating an example hardware configuration of a terminal;

FIG. 5 is a block diagram illustrating an example hardware configuration of a relay server;

FIG. 6 is a block diagram illustrating an example functional configuration of the terminal;

FIG. 7 is a sequence diagram illustrating an example process performed by the videoconference system;

FIG. 8 is a diagram illustrating an example of environment information;

FIG. 9 is a diagram illustrating an example of transmitter-side environment information; and

FIGS. 10A and 10B (FIG. 10) are a flowchart illustrating an example process for determining coding settings.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A communication apparatus, a communication system, a communication method, and a program according to embodiments of the present invention will be described in detail hereinafter with reference to the accompanying drawings. In the following, a communication system according to an embodiment of the present invention exemplifies a videoconference system for transmitting and receiving video data and audio data among a plurality of videoconference terminals (corresponding to “communication apparatuses”) to implement a multipoint teleconference. In the videoconference system, video data of an image captured using one of the videoconference terminals is coded using scalable video coding (SVC) (hereinafter also referred to as “scalably coded”, as appropriate). SVC is an example of “scalable coding”. The coded video data is then transmitted to other videoconference terminals, and the other videoconference terminals decode the coded video data and reproduce and output the decoded video data. It is to be understood that the present invention is also applicable to any other communication system, The present invention is widely applicable to various communication systems for transmitting and receiving scalably coded data among a plurality of communication apparatuses and also to various communication terminals included in such communication systems.

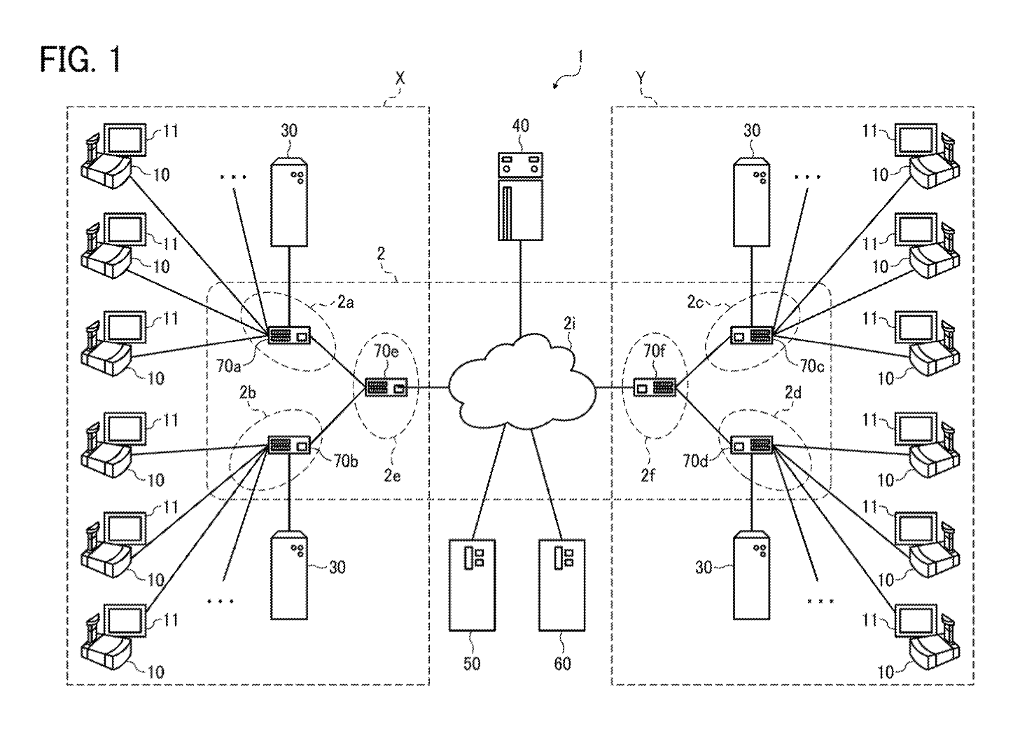

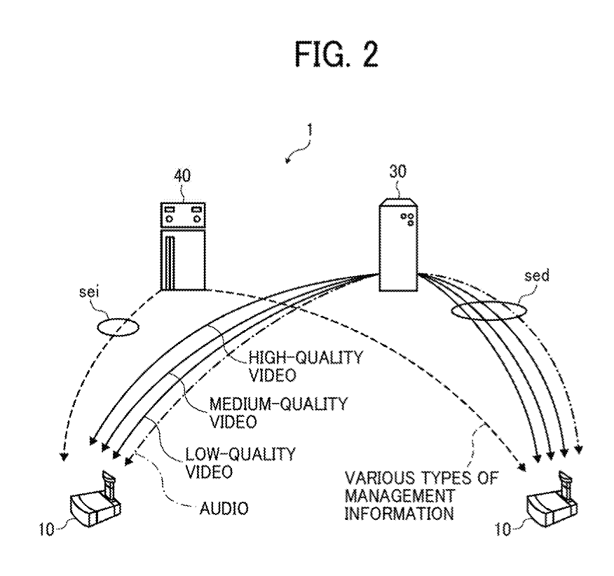

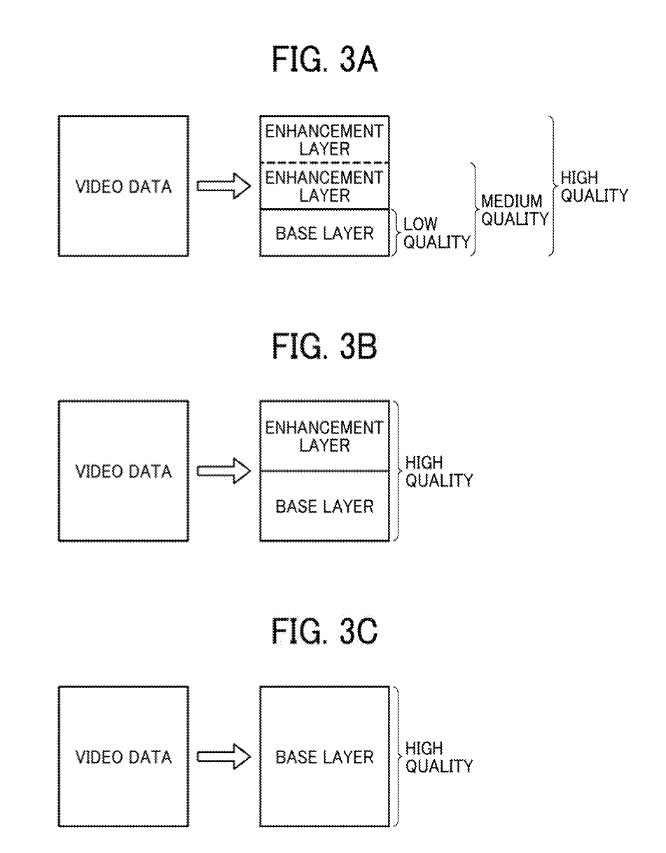

FIG. 1 is a schematic configuration diagram of a videoconference system 1 according to this embodiment. FIG. 2 is an illustration of an overview of communication in the videoconference system 1 according to this embodiment. FIGS. 3A to 3C are illustrations for explaining video data coding schemes according to this embodiment.

As illustrated in FIG. 1, the videoconference system 1 according to this embodiment includes a plurality of videoconference terminals (hereinafter referred to simply as “terminals”) 10, a plurality of displays 11, a plurality of relay servers 30, a management server 40, a program providing server 50, and a maintenance server 60. The terminals 10 and the displays 11 are located at the respective nodes.

Each of the displays 11 is connected to the corresponding one of the terminals 10 through a wired or wireless network. The display 11 and the terminal 10 may be integrated into a single device.

The terminals 10 and the relay servers 30 are connected to routers through a local area network (LAN), for example. The routers are network devices that select a route to transmit data. In the example illustrated in FIG. 1, the routers include a router 70a in a LAN 2a, a router 70b in a LAN 2b, a router 70c in a LAN 2c, a router 70d in a LAN 2d, a router 70e connected to the routers 70a and 70b via a dedicated line 2e and also connected to the Internet 2i, and a router 70f connected to the routers 70c and 70d via a dedicated line 2f and also connected to the Internet 2i.

The LANs 2a and 2b are assumed to be set up in different locations within an area X, and the LANs 2c and 2d are assumed to be set up in different locations within an area Y. For example, the area X is Japan and the area Y is the United States. The LAN 2a is set up in an office in Tokyo, the LAN 2b is set up in an office in Osaka, the LAN 2c is set up in an office in New York, and the LAN 2d is set up in an office in Washington, D.C. In this embodiment, the LAN 2a, the LAN 2b, the dedicated line 2e, the Internet 2i, the dedicated line 2f, the LAN 2c, and the LAN 2d establish a communication network 2. The communication network 2 may include locations where wired communication takes place and locations where wireless communication such as Wireless Fidelity (WiFi) communication or Bluetooth (registered trademark) communication takes place.

In the videoconference system 1 according to this embodiment, video data and audio data are transmitted and received among the plurality of terminals 10 via, the relay servers 30. In this case, as illustrated in FIG. 2, a management information session Sei is established among the plurality of terminals 10 via the management server 40 to transmit and receive various types of management information. A data session Sed is also established among the plurality of terminals 10 via the relay servers 30 to transmit and receive video data and audio data. The video data transmitted and received in the data session Sed is scalably coded data. For instance, coded data of high-quality video, coded data of medium-quality video, and coded data of low-quality video are transmitted and received on different channels (layers).

The video data may be scalably coded using a standard coding format, examples of which include H.264/SVC (H264/Advanced Video Coding (AVC) Annex G). In the H.264/SVC format, video data is convened into data in a hierarchical structure and is coded as a set of pieces of video data having different qualities, so that pieces of coded data corresponding to the pieces of video data of the respective qualities can be transmitted and received on a plurality of channels. In this embodiment, video data is coded using the H.264/SVC format to generate coded data which is transmitted and received among the plurality of terminals 10.

FIGS. 3A to 3C are diagrams illustrating video data coding schemes. In the videoconference system 1 according to this embodiment, when the number of layers is determined to be three, for example, as illustrated in FIG. 3A, video data is converted into data in a hierarchical structure having a base layer and enhancement layers (a lower enhancement layer and an upper enhancement layer). The video data including the base layer alone is low-quality video data, the video data including the base layer and the lower enhancement layer is medium-quality video data, and the video data including the base layer, the lower enhancement layer, and the upper enhancement layer is high-quality video data. The video data of the respective qualities is coded and transmitted on three channels.

When the number of layers is determined to be two, for example, as illustrated in FIG. 3B, video data is converted into data in a hierarchical structure having a base layer and an enhancement layer. The video data including the base layer alone is low-quality video data, and the video data including the base layer and the enhancement layer is high-quality video data. The video data of the respective qualities is coded and transmitted on two channels.

When the number of layers is determined to be one, for example, as'illustrated in FIG. 3C, video data is converted into data including the base layer alone. The video data including the base layer alone is high-quality video data, and is coded and transmitted on a single channel.

As illustrated in FIG. 3A, when video data is transmitted on three channels, a receiver can receive and reproduce at least the low-quality video data of the base layer even if the communication environment of the receiver changes markedly.

As illustrated in FIG. 3C, when video data is transmitted on a single channel, a receiver can receive an image of higher quality than when video data is transmitted on three channels as illustrated in FIG. 3A if the communication environment of the receiver changes slightly. This is because overhead occurs when video data is scalably coded into a plurality of layers such as the base layer, the lower enhancement layer, and the upper enhancement layer.

Accordingly, more layers used for scalable coding of video data can address more changes in communication environment, but can cause lower quality of the video data when data of all the layers is decoded.

The relay servers 30 are each a computer that relays transmission of video data and audio data among a plurality of terminals 10. As described above, the video data relayed by each relay server 30 is data scalably coded using the H.264/SVC format described above, for example. The relay server 30 receives scalably coded video data of all the qualities from a terminal 10 on the transmitter side by using a plurality of channels. Then, the relay server 30 selects a channel corresponding to a desired quality in accordance with the state of each terminal 10 on the receiver side, such as the network state or the display resolution of video, and transmits only the coded data corresponding to the selected channel to the terminal 10 on the receiver side.

The management server 40 is a computer that manages the entirety of the videoconference system 1 according to this embodiment. For example, the management server 40 manses the states of the terminals 10, which have been registered, the states of the relay servers 30, the logins of users who use the terminals 10, and the data session Sed established among the terminals 10.

The program providing server 50 is a computer that provides various pay mems to, for example, the terminals 10, the relay servers 30, the management server 40, and the maintenance server 60.

The maintenance server 60 is a computer for providing maintenance, management, or servicing of at least the terminals 10, the relay servers 30, the management server 40, or the program providing server 50.

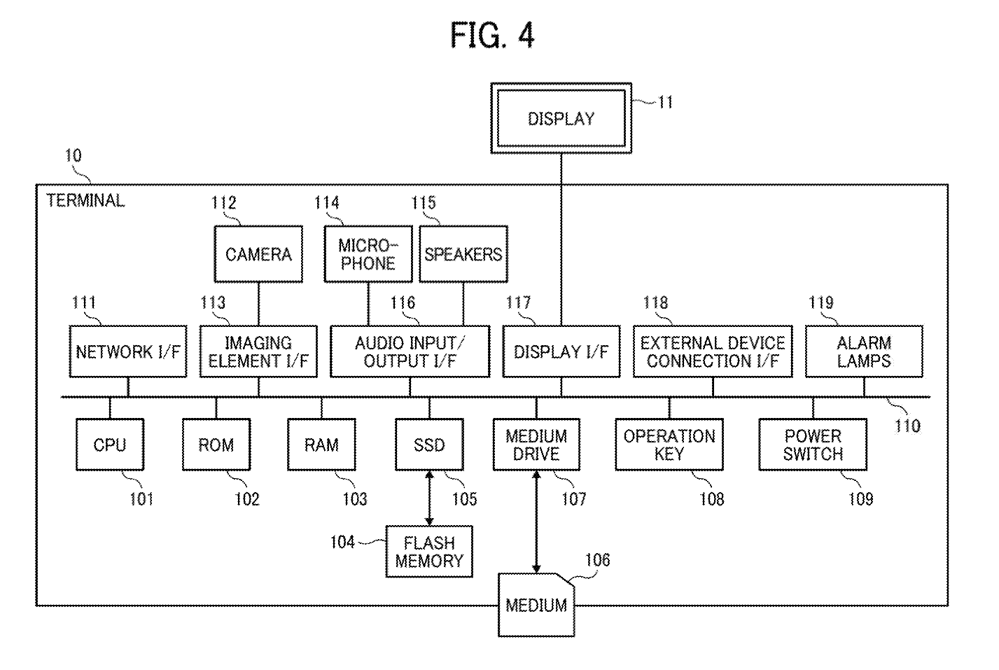

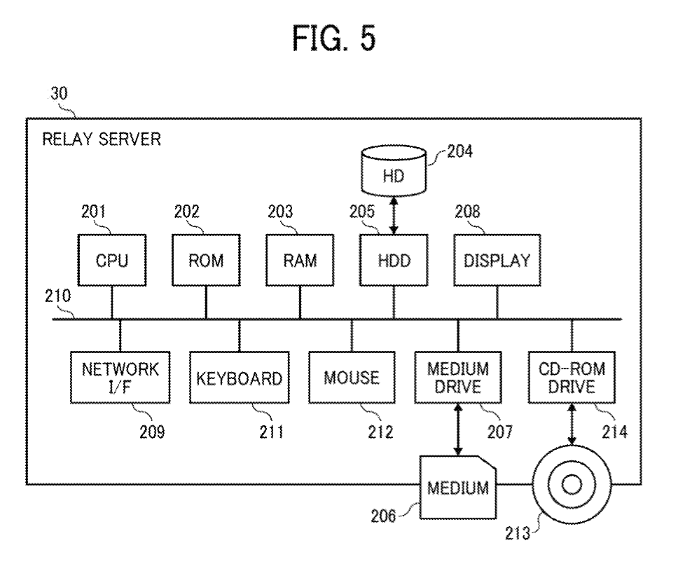

A description will now be provided of the hardware configuration of the terminals 10, the relay servers 30, the management server 40, the program providing server 50, and the maintenance server 60 in the videoconference system 1 according to this embodiment. FIG. 4 illustrates an example hardware configuration of each of the terminals 10, and FIG. 5 illustrates an example hardware configuration of each of the relay servers 30. The hardware configuration of the management server 40, the program providing server 50, and the maintenance server 60 can be similar to that of the relay servers 30. For this reasons, description of the hardware configuration is omitted.

As illustrated in FIG. 4, the terminal 10 includes a central processing unit (CPU) 101, a read only memory (ROM) 102, a random access memory (RAM) 103, a flash memory 104, a solid state drive (SSD) 105, a medium drive 107, an operation key 108, a power switch 109, and a network interface (I/F) 111. The CPU 101 controls the overall operation of the terminal 10. The ROM 102 stores a program used for driving the CPU 101, such as an initial program loader (IPL). The RAM 103 is used as a work area for the CPU 101. The flash memory 104 stores a terminal program and various types of data such as image data and audio data. The SSD 105 controls reading or writing of various types of data from or to the flash memory 104 under control of the CPU 101. The medium drive 107 controls reading or writing (storage) of data from or to a recording medium 106 such as a flash memory. The operation key 108 is operated to select a partner terminal 10 with which the terminal 10 communicates. The power switch 109 is used to switch on and off of the terminal 10, The network I/F 111 transmits data using the communication network 2.

The terminal 10 further includes a built-in camera 112, an imaging element I/F 113, a built-in microphone 114, one or more built-in speakers 115, an audio input/output I/F 116, a display I/F 117, an external device connection I/F 118, one or more alarm lamps 119, and a bus line 110. The camera 112 captures an image of a subject to obtain image data under control of the CPU 101. The imaging element I/F 113 controls driving of the camera 112. The microphone 114 receives input audio. The speakers 115 output audio. The audio input/output I/F 116 handles input and output of an audio signal through the microphone 114 and the speakers 115 under control of the CPU 101. The display I/F 117 transmits data of display video to the display 11 under control of the CPU 101. The external device connection I/F 118 is used for connection of various external devices. The alarm lamps 119 alert the user of the terminal 10 to various malfunctions of the terminal 10. The bus line 110 is used to electrically connect the components described above to one another, and examples of the bus line 110 include an address bus and a data bus.

The camera 112, the microphone 114, and the speakers 115 may not necessarily be incorporated in the terminal 10, but may be external to the terminal 10. The display 11 may be incorporated in the terminal 10. The display 11 is, for example, but not limited to, a display device such as a liquid crystal panel. The display 11 may be an image projection device such as a projector. The hardware configuration of the terminal 10 illustrated in FIG. 4 is merely an example and the terminal 10 may further include any other hardware component.

The terminal program described above, which is provided by the program providing server 50, is stored in, for example, the flash memory 104 and is loaded into the RAM 103 for execution under control of the CPU 101. The terminal program may be stored in any non-volatile memory which may he a memory other than the flash memory 104, such as an electrically erasable and programmable ROM (EEPROM). The terminal program may be recorded and provided on a computer-readable recording medium such as the recording medium 106 as a file in an installable or executable format. Alternatively, the terminal program may be provided as an embedded program that is stored in advance in the ROM 102 or the like.

As illustrated in FIG. 5, the relay server 30 includes a CPU 201, a ROM 202, a RAM 201, a hard disk (HD) 204, an HD drive (HDD) 205, a medium drive 207, a display 208, a network I/F 209, a keyboard 211, a mouse 212, a compact disc read only memory (CD-ROM) drive 214, and a bus line 210. The CPU 201 controls the overall operation of the relay server 30. The ROM 202 stores a program used for driving the CPU 201, such as an IPL. The RAM 203 is used as a work area for the CPU 201. The HD 204 stores various types of data such as a relay server program. The HDD 205 controls reading or writing of various types of data from or to the HD 204 under control of the CPU 201. The medium drive 207 controls reading or writing (storage) of data from or to a recording medium 206 such as a flash memory. The display 208 displays various types of information. The network I/F 209 transmits data using the communication network 2. The CD-ROM drive 214 controls reading or writing of various types of data from or to a CD-ROM 213, which is an example of a removable recording medium. The bus line 210 is used to electrically connect the components described above to one another, and examples of the bus line 210 include an address bus and a data bus.

The relay server program described above, which is provided from the program providing server 50, is stored in, for example, the HD 204 and is loaded into the RAM 203 for execution under control of the CPU 201. The relay server program may be recorded and provided on a computer-readable recording medium such as the recording medium 206 or the CD-ROM 213 as a file in an installable or executable format. Alternatively, the relay server program may be provided as, an embedded program that is stored in advance in the ROM 202 or the like.

The management server 40 can have a hardware configuration similar to that of the relay server 30 illustrated in FIG. 5. The HD 204 stores a management server program provided from the program providing server 50. The management server program may also be recorded and provided on a computer-readable recording medium such as the recording medium 206 or the CD-ROM 213 as a file in an installable or executable format. Alternatively, the management server program may be provided as an embedded program that is stored in advance in the ROM 202 or the like.

Other examples of the removable recording medium include computer-readable recording media such as a compact disc recordable (CD-R), a digital versatile disk (DVD), and a Blu-ray disc. The various programs described above may be recorded and provided on such recording media.

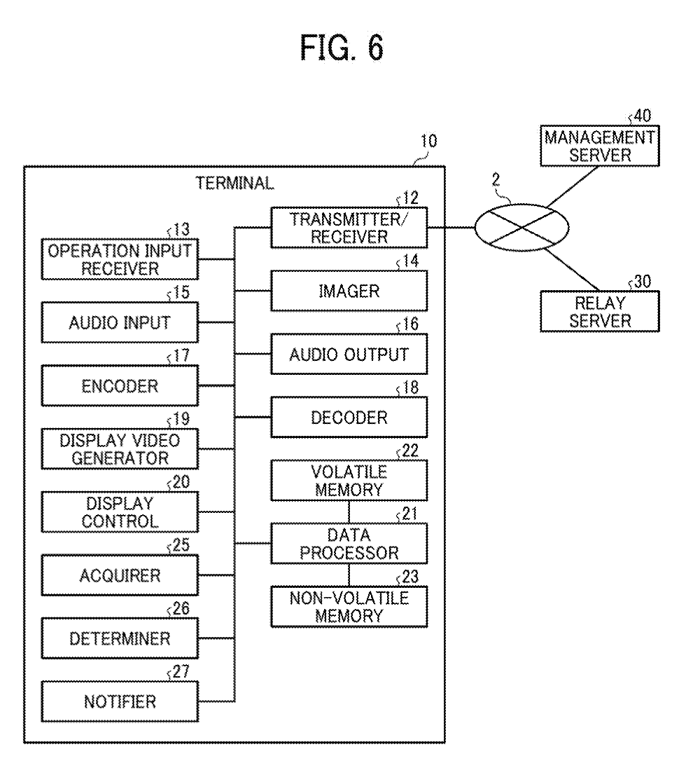

The functional configuration of the terminal 10 will now be described. FIG. 6 is a block diagram illustrating an example functional configuration of the terminal 10. As illustrated in FIG. 6, the terminal 10 includes a transmitter/receiver 12, an operation input receiver 13, an imager 14, an audio input 15, an audio output 16, an encoder 17, a decoder 18, a display video generator 19, a display control 20, a data processor 21, a volatile memory 22, a non-volatile memory 23, an acquirer 25, a determiner 26, and a notifier 27.

The transmitter/receiver 12 transmits and receives various types of data (or information) to and from devices such as other terminals 10, the relay servers 30, and the management server 40 via the communication network 2. The transmitter/receiver 12 is implemented by the network I/F 111 and instructions of the CPU 101 illustrated in FIG. 4, for example.

The operation input receiver 13 receives various input operations performed by a user who uses the terminal 10. The operation input receiver 13 is implemented by the operation key 108, the power switch 109, and instructions of the CPU 101 illustrated in FIG. 4, for example.

The imager 14 captures video of the location where the terminal 10 is located and outputs video data. The imager 14 is implemented by the camera 112, the imaging element I/F 113, and instructions of the CPU 101 illustrated in FIG. 4, for example.

The audio input 15 receives audio input at the location where the terminal 10 is located and outputs audio data. The audio input 15 is implemented by the microphone 114, the audio input/output I/F 116, and instructions of the CPU 101 illustrated in FIG. 4, for example.

The audio output 16 reproduces and outputs audio data. The audio output 16 is implemented by the speakers 115, the audio input/output I/F 116, and instructions of the CPU 101 illustrated in FIG. 4, for example.

The encoder 17 codes the video data output from the imager 14 or the audio data output from the audio input 15 and generates coded data. The encoder 17 scalably codes the video data in accordance with the H.264/SVC format. The encoder 17 can change settings for scalably coding the video data (for example, settings for the layer configuration of data to be coded) in accordance with a setting signal from the determiner 26 described below. The encoder 17 is implemented by, for example, instructions of the CPU 101 illustrated in FIG. 4 executing a coding/decoding program (video/audio codec) included in the terminal program described above.

The decoder 18 decodes coded data transmitted from other terminals 10 through the relay servers 30 and outputs the original video data or audio data. The decoder 18 is implemented by, for example, the CPU 101 illustrated in FIG. 4 executing the coding/decoding program (video/audio codec) included in the terminal program described above.

The display video generator 19 uses the video data decoded by the decoder 18 to generate display video to be displayed on (reproduced and output from) the display 11. For example, when the video data decoded by the decoder .18 includes pieces of video data that are transmitted from a plurality of terminals 10 at a plurality of points, the display video generator 19 generates display video in accordance with layout settings determined in advance or layout settings specified by the user in such a manner that each of the pieces of video data is contained in a screen of the display video.

The display video generator 19 is implemented by, for example, instructions of the CPU 101 illustrated in FIG. 4 executing a display video generation program included in the terminal program described above.

The display control 20 controls the display 11 to display (reproduce and output) the display video generated by the display video generator 19. The display control 20 is implemented by the display I/F 117 and instructions of the CPU 101 illustrated in FIG. 4, for example.

The data processor 21 performs processing to store or read various types of data in or from the volatile memory 22 or the non-volatile memory 23. The data processor 21 is implemented by the SSD 105 and instructions of the CPU 101 illustrated in FIG. 4, for example. The volatile memory 22 is implemented by the RAM 103 illustrated in FIG. 4, for example. The non-volatile memory 23 is implemented by the flash memory 104 illustrated in FIG. 4, for example.

The acquirer 25 acquires environment information 121 indicating communication environments where the terminal 10 and other terminals 10 receive data. The acquirer 25 further acquires transmitter-side environment information 122 indicating a communication environment where the terminal 10 transmits data.

The acquirer 25 is implemented by, for example, the CPU 101 illustrated in FIG. 4 executing a program included in the terminal program described above.

The determiner 26 determines the number of layers for scalable coding based on the environment information 121 and the transmitter-side environment information 122 acquired by the acquirer 25.

The determiner 26 is implemented by, for example, the CPU 101 illustrated in FIG. 4 executing a program included in the terminal program described above.

The notifier 27 notifies other terminals 10 of the environment information 121 indicating the communication environment of the terminal 10.

The notifier 27 is implemented by, for example, the CPU 101 illustrated in FIG. 4 executing a program included in the terminal program described above.

<Processes>

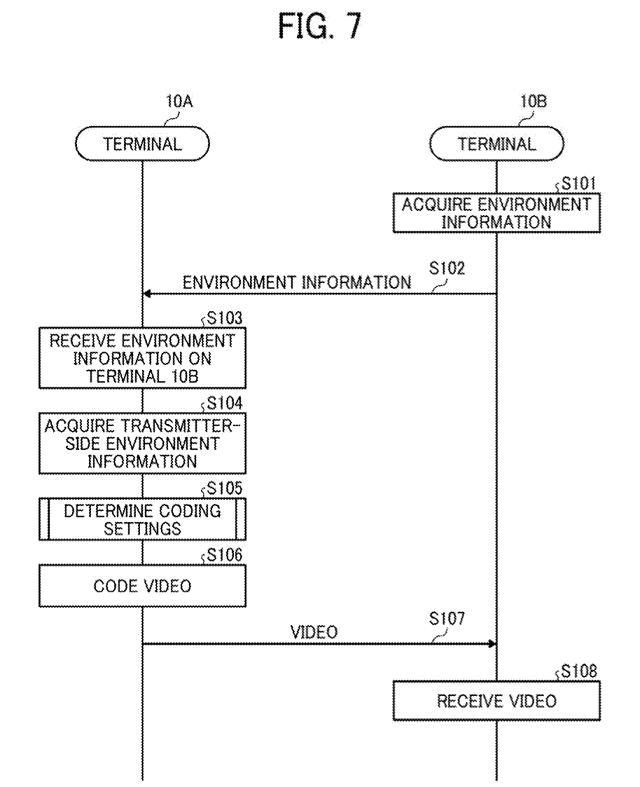

Processes performed by the videoconference system I will now be described with reference to FIG. 7. FIG. 7 is a sequence diagram illustrating an example process performed by the videoconference system 1. In the following, two terminals 10 used to conduct a videoconference are referred to as a terminal 10A and a terminal 10B.

In step S101, the acquirer 25 of the terminal 10B acquires the environment information 121 indicating a communication environment where the terminal 10B receives data.

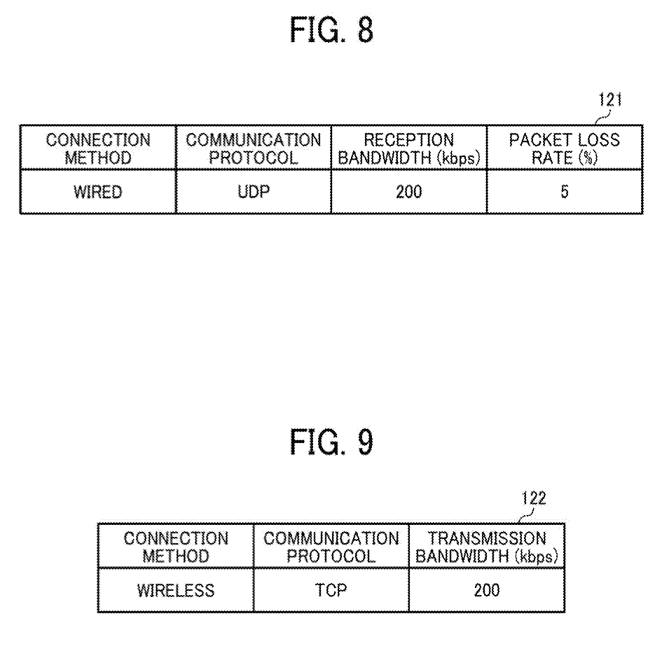

FIG. 8 is a diagram illustrating an example of the environment information 121. The environment information 121 includes information on a connection method, a communication protocol, a reception bandwidth, and a packet loss rate. The terminal 10B stores the environment information 121 on its memory, such as the RAM 103 under control of the CPU 101.

The connection method is information indicating whether the currently accessed communication network supports wired or wireless connection. Wired connection is determined in the case of a connection between the terminal 10B and a communication device such as a router via a cable. Wireless connection is determined in the case of a connection between the terminal 10B and a communication device such as a router via wireless radio waves. Wireless connection is more likely to cause a change in communication status than wired connection. The connection method may be acquired and stored in any desired memory, such as a local memory of the terminal 10B, when the connection is established with the terminal 10A.

The communication protocol is information indicating a protocol used to receive content data. Examples of the communication protocol include User Datagram Protocol (UDP) and Transmission Control Protocol (TCP). UDP is a protocol used when, for example, immediacy of communication is desired, and TCP is a protocol used when, for example, reliability of communication is desired. The communication protocol may be acquired and stored in any desired memory, such as a local memory of the terminal 10B, when the connection is established with the terminal 10A.

In a videoconference, UDP is generally used for transmission and reception of content data such as video data. However, TCP is used in some cases such as when UDP communication is not allowed in an enterprise network due to security reasons. In such a case, a retransmission on the transmitter side due to packet loss may lead to more intense traffic congestion. Hence, TCP is more likely to cause a change in communication status than UDP.

The reception bandwidth is information indicating a bandwidth at which data or the like can be received. For example, the reception bandwidth is the sum of the respective reception bandwidths of video data, audio data, and any other type in the actual communication results. Alternatively, the reception bandwidth may be the reception bandwidth of video in the actual communication results. Alternatively, a maximum communication speed within a predetermined period may be used as a reception bandwidth. The reception bandwidth may be calculated using any desired known method. For example, the reception bandwidth may be calculated based on, for example, a time when data is received at the router after such data is transmitted from one communication apparatus (such as the terminal 10B).

The packet loss rate is calculated based on, for example, the rate of response to packets of video data, audio data, and other information in the actual communication results. The packet loss rate may be calculated using any desired known method.

Referring back to FIG. 7, the notifier 27 of the terminal 10B notifies the terminal 10A of the environment information 121 on the terminal 100 (step S102).

The acquirer 25 of the terminal 10A acquires the environment information 121 received from the terminal 10B (step S103).

The acquirer 25 of the terminal 10A acquires the transmitter-side environment information 122 indicating a communication environment where the terminal 10A transmits data (step S104).

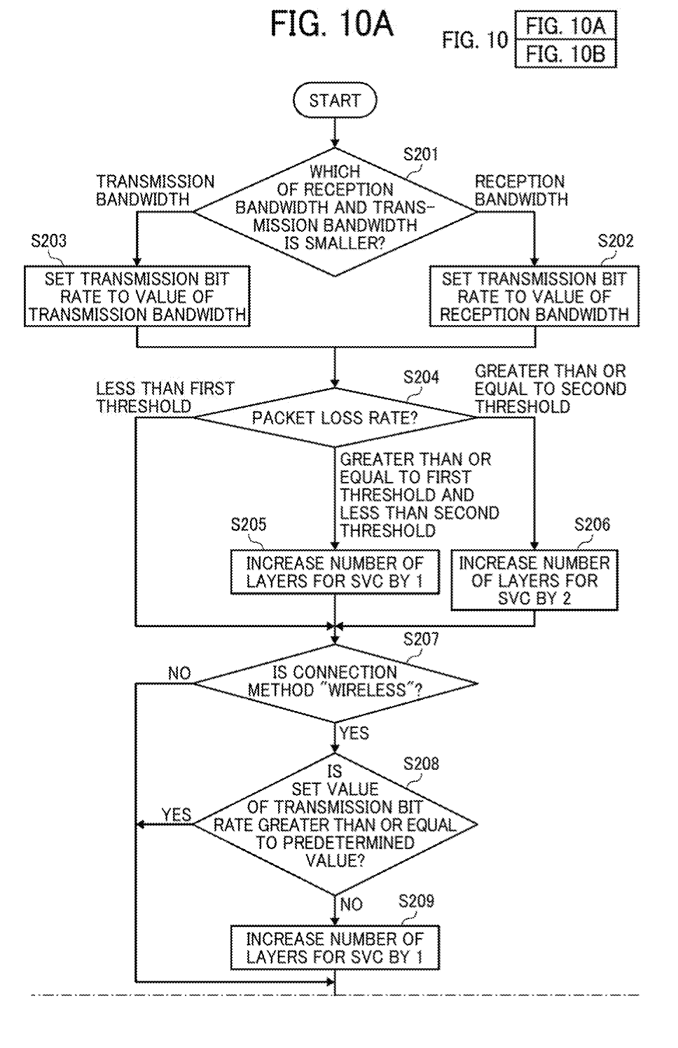

FIG. 9 is a diagram illustrating an example of the transmitter-side environment information 122. The transmitter-side environment information 122 includes information on a connection method, a communication protocol, and a transmission bandwidth. The terminal 10A stores the environment information 122 on its memory, such as the RAM 103 under control of the CPU 101. Any item of the environment information 122 may be obtained in a substantially similar manner as described above for the case of obtaining the environment information 121.

The connection method is information indicating whether the currently accessed communication network supports wired or wireless connection. Wired connection is determined in the case of a connection between the terminal 10A and a communication device such as a router via a cable. Wireless connection is determined in the case of a connection between the terminal 10A and a communication device such as a router via wireless radio waves. Wireless connection is more likely to cause a change in communication status than wired connection.

The communication protocol is information indicating a protocol used to transmit content data. Examples of the communication protocol include User Datagram Protocol (UDP) and Transmission Control Protocol (TCP). UDP is a protocol used when, for example, immediacy of communication is desired, and TCP is a protocol used when, for example, reliability of communication is desired.

When the communication protocol it in the environment information 121 on the terminal 10B is different from the communication protocol included in the transmitter-side environment information 122 on the terminal 10A, for example, the relay server 30 or the like converts one of the communication protocols to the other communication protocol.

The transmission bandwidth is information indicating a bandwidth at which data or the like can be transmitted. For example, the transmission bandwidth is the sum of the respective transmission bandwidths of video, audio, data, and any other type in the actual communication results. Alternatively, the transmission bandwidth may be the transmission bandwidth of video in the actual communication results. Alternatively, a maximum communication speed within a predetermined period may be used as a transmission bandwidth.

When the reception bandwidth included in the environment information 121 on the terminal 10B is different from the transmission bandwidth included in the transmitter-side environment information 122 on the terminal 10A, for example, the relay server 30 or the like may relay only coded data corresponding to a channel in accordance with the terminal 10 on the receiver side to the terminal 10 on the receiver side.

Referring to FIG. 7, the determiner 26 of the terminal 10A determines coding settings based on the environment information 121 on the terminal 10B and the transmitter-side environment information 122 on the terminal 10A (step S105).

The encoder 7 of the terminal 10A codes video in accordance with the determined cooling settings (step S106).

Then, the transmitter/receiver 12 of the terminal 10A transmits the coded video to the terminal 10B via the relay server 30 (step S107).

Then, the transmitter/receiver 12 of the terminal 10B receives the coded video (step S108).

The terminal 10B may also perform processing similar to the processing performed by the terminal 10A to determine coding settings.

<<Determination of Coding Settings>>

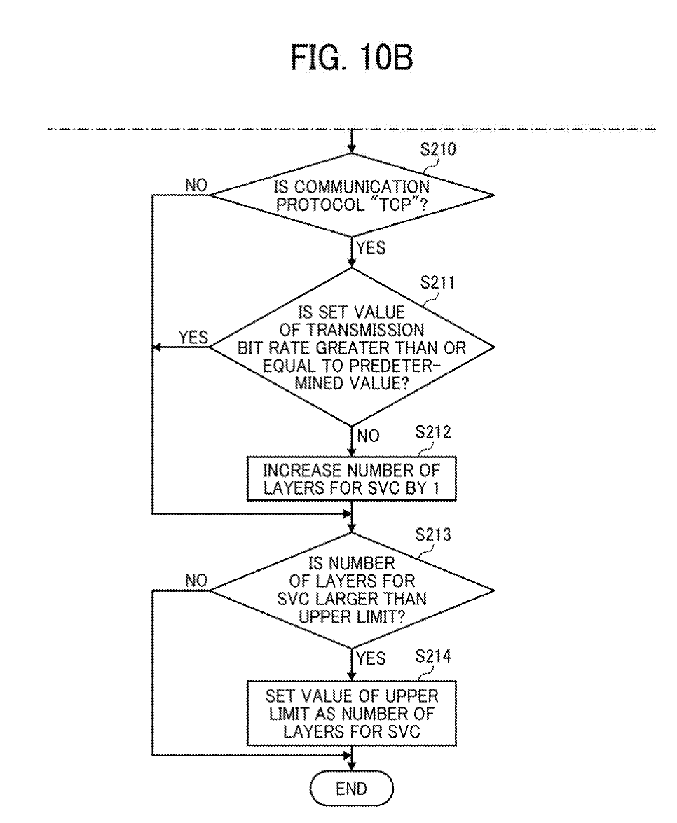

The process for determining coding settings in step S105 will now be described with reference to FIGS. 10A and 10B (FIG. 10). FIG. 10 is a flowchart illustrating an example process for determining coding settings.

It is assumed that the number of layers for SVC has been initialized to “1” when the process for determining coding settings is performed.

In step S201, the determiner 26 of the terminal 10A determines which of the reception bandwidth included in the environment information 121 on the terminal 10B and the transmission bandwidth included in the transmitter-side environment information 122 on the terminal 10A is smaller.

If the reception bandwidth included in the environment information 121 on the terminal 10B is smaller (“reception bandwidth” in step S201), the determiner 26 of the terminal 10A sets the transmission bit rate to the value of the reception bandwidth (step S202). Then, the process proceeds to step S204.

If the transmission bandwidth included in the transmitter-side environment information 122 on the terminal 10A is smaller (“transmission bandwidth” in step S201), the determiner 26 of the terminal 10A sets the transmission bit rate to the value of the transmission bandwidth (step S203).

Then, the determiner 26 of the terminal 10A determines the packet loss rate included in the environment information 121 on the terminal 10B (step S204).

If the packet loss rate is less than a first threshold (for example, 1%) “less than first threshold” in step S204), the process proceeds to step S207.

If the packet loss rate is greater than or equal to the first threshold and is less than a second threshold (for example, 5%) larger than the first threshold (“greater than or equal to first threshold and less than second threshold” in step S204), the determiner 26 of the terminal 10A increases the number of layers for SVC by 1 (step S205). Then, the process proceeds to step S207.

If the packet loss rate is greater than or equal to the second threshold (“greater than or equal to second threshold” in step S204), the determiner 26 of the terminal 10A increases the number of layers for SVC by 2 (step S206).

Then, the determiner 26 of the terminal 10A determines whether at least either the connection method included in the environment information 121 on the terminal 10B or the connection method included in the transmitter-side environment information 122 on the terminal 10A is “wireless” (step S207).

If either of the connection methods is “wireless” (NO in step S207), the process proceeds to step S210.

If at least either of the connection methods is “wireless” (YES in step S207), the determiner 26 of the terminal WA determines whether the bit rate set in step S202 or S203 is greater than or equal to a predetermined value (for example, 1 Mbps) (step S208).

If the set bit rate is greater than or equal to the predetermined value (YES in step S208), the process proceeds to step S210.

If the set bit rate is not greater than or equal to the predetermined value (NO in step S208), the determiner 26 of the terminal 10A increases the number of layers for SVC by 1 (step S209). This is because it can be estimated that the communication quality is not high when the set bit rate is not greater than or equal to the predetermined value.

Then, the determiner 26 of the terminal 10A determines whether at least either the communication protocol included in the environment information 121 on the terminal 10B or the communication protocol included in the transmitter-side environment information 122 on the terminal 10A is “TCP” (step S210).

If neither of the communication protocols is “TCP” (NO in step S210), the process proceeds to step S213.

If at least either of the communication protocols is “TCP” (YES in step S210), the determiner 26 of the terminal 10A determines whether the bit rate set in step S202 or S203 is greater than or equal to a predetermined value (for example, 1 Mbps) (step S211).

If the set bit rate is greater than or equal to the predetermined value (YES in step S211), the process proceeds to step S213.

If the set bit rate is not greater than or equal to the predetermined value (NO in step S211), the determiner 26 of the terminal 10A increases the number of layers for SVC by 1 (step S212).

Then, the determiner 26 of the terminal 10A determines whether the number of layers for SVC is larger than an upper limit (for example, 3) (step S213).

If the number of layers for SVC is not larger than the upper limit (NO in step S213), the process ends.

If the number of layers for SVC is lamer than the upper limit (YES in step S213), the determiner 26 of the terminal 10A sets the value of the upper limit as the number of layers for SVC (step S214), Then, the process ends.

In the videoconference system 1 according to this embodiment, as described above in detail with reference to a specific example, a terminal 10 on the receiver side sends environment information indicating a communication environment to a terminal 10 on the transmitter side from which video is transmitted. The terminal 10 on the transmitter side determines the number of layers for scalable coding to be transmitted to the terminal 10 on the receiver side based on the environment information sent from the terminal 10 on the receiver side. Accordingly, a change in the quality of content in accordance with the status of the communication network can be reduced.

While a specific embodiment of the present invention has been described, the present invention is not limited to the embodiment described above and various modifications and variations can be made to the present invention without departing from the scope of the invention. In other words, the specific configurations and operations of the videoconference system 1, the terminal 10, and other devices described in the foregoing embodiment are given for illustrative purposes and can be modified variously in accordance with their application and purpose.

For example, in the embodiment described above, the terminal 10 includes the acquirer 25 and the determiner 26. Alternatively, some or all of the functions of the acquirer 25 and the determiner 26 may be included in any other device such as the management server 40. For example, referring back to FIG. 7, the terminal 10B may send environment information to the terminal 10A via the management server 40, which controls communication between the terminal 10A and the terminal 10B. In another example, the management server 40 may receive environment information respectively from the terminal 10A and the terminal 10B, and performs S105 of determining coding settings based on the received environment information. The management server 40 then outputs a determination result to the terminal 10A to request the terminal 10A to transmit the content data according to the determined coding settings.

In the embodiment described above, furthermore, video data is scalably coded and is transmitted and received among the terminals 10. In addition to or instead of video data, audio data may be scalably coded and transmitted and received among the terminals 10. In this case, measures of the quality of audio data include, for example, the audio sampling frequency and the audio bit length. The audio sampling frequency and the audio bit length may be obtained using any desired known method.

In the embodiment described above, furthermore, the videoconference system 1 has been given as a non-limiting example of a communication system according to an embodiment of the present invention. The present invention is effectively applicable to various communication systems, for example, a telephone system such as an Internet protocol (IP) phone system for two-way transmission and reception of audio data between terminals and a car navigation system for delivering map data or route information to car navigation devices mounted in automobiles from a terminal in an administration center.

In the embodiment described above, furthermore, each of the videoconference terminals (terminals) 10 has been given as a non-limiting example of a communication apparatus according to an embodiment of the present invention. The present invention is effectively applicable to various communication apparatuses having a function of scalably coding and transmitting various types of data and a function of decoding and reproducing scalably coded data, such as a personal computer (PC), a tablet terminal, a smartphone, an electronic whiteboard, and a car navigation device mounted in an automobile.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes programmed processor, as a processor includes circuitry. A processing circuit also includes devices such as an application specific integrated circuit (ASIC) digital signal processor (DSP), field programmable gate array (FPGA), and conventional circuit components arranged to perform the recited functions.

1. A communication apparatus communicable with a counterpart communication apparatus, the communication apparatus comprising:
circuitry to
acquire receiver-side environment information indicating a communication environment of the counterpart communication apparatus that receives content data from the communication apparatus,
determine a number of layers of the content data for scalable coding, based on the receiver-side environment information, and
code the content data in the determined number of layers by using the scalable coding; and
a transmitter to transmit the coded content data to the counterpart communication apparatus through a communication network.

2. The communication apparatus according to claim 1, wherein the scalable coding includes scalable video coding, and the content data includes video data.

3. The communication apparatus according to claim 1, wherein the receiver-side environment information includes information on at least one of a reception bandwidth indicating a bandwidth at which the content data can be received, a packet loss rate indicating a rate of response to the content data, a connection method used to connect the counterpart communication apparatus to the communication network, and a protocol used to receive the content data.

4. communication apparatus according to claim 1,
wherein the circuitry further acquires transmitter-side environment information indicating a communication environment of the communication apparatus that transmits the content data, and
wherein the number of layers of the content data for the scalable coding is determined based on the receiver-side environment information and the transmitter-side environment information.

5. The communication apparatus according to claim 4, wherein the transmitter-side environment information includes information on at least one of a transmission bandwidth indicating a bandwidth at which the content data can be transmitted, a connection method used to connect the communication apparatus to the communication network, and a protocol used to transmit the content data.

6. A communication system comprising:
the communication apparatus according to claim 1;
the counterpart communication apparatus; and
a relay server to control relay of the coded content data to the counterpart communication apparatus for each layer of the coded content data.

7. A communication system comprising circuitry to:
acquire receiver side environment information indicating a communication environment of the counterpart communication apparatus that receives content data from the communication apparatus;
determine a number of layers of the content data for scalable coding, based on the receiver-side environment information;
code the content data in the determined number of layers by using the scalable coding; and
transmit the coded content data to the counterpart communication apparatus through a communication network.

8. A method of controlling communication of a communication apparatus with a counterpart communication apparatus, the method comprising:
acquiring receiver-side environment information indicating a communication environment of the counterpart communication apparatus that receives content data from the communication apparatus;
determining a number of layers of the content data for scalable coding, based on the receiver-side environment information;
coding the content data in the determined number of layers by using the scalable coding; and
transmitting the coded content data to the counterpart communication apparatus through a communication network.
